(19) United States
(12) Patent Application Publication
(10) Pub. No.: US 2022/0114556 A1
(43) Pub. Date: Apr. 14, 2022

(54) Method, System and Apparatus for Contactless Clock-In and Clock-Out

(71) Applicants: Manjot Singh, Ludhiana (IN); Soneeka Arora, Naperville, IL (US); Amrinder Arora, Centreville, VA (US)

(72) Inventors: Manjot Singh, Ludhiana (IN); Soneeka Arora, Naperville, IL (US); Amrinder Arora, Centreville, VA (US)

(21) Appl. No.: 17/067,327

(22) Filed: Oct. 9, 2020

(51) Int. Cl. G06Q 10/10; G06F 21/36; G06K 7/14; G06K 7/10

(52) U.S. Cl. CPC G06Q 10/1091; G06K 7/10386; G06K 7/1417; G06F 21/36

(57) ABSTRACT

A method, system and apparatus for an efficient and contactless way to clock-in and clock-out in the daily routine. It is a communication between two devices and this communication sends a code as part of this communication which is then used for clock-in. This system generally includes two devices. The first application displays the QR code which has an embed TVC value and the second application has the functionality of scanning the QR code by using the back camera and then getting the embedded TVC value from the first application and passing as a parameter in the service call for Clock-In.

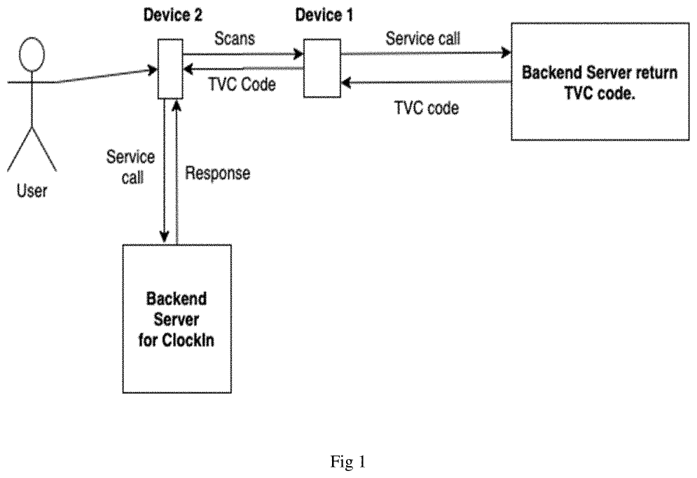

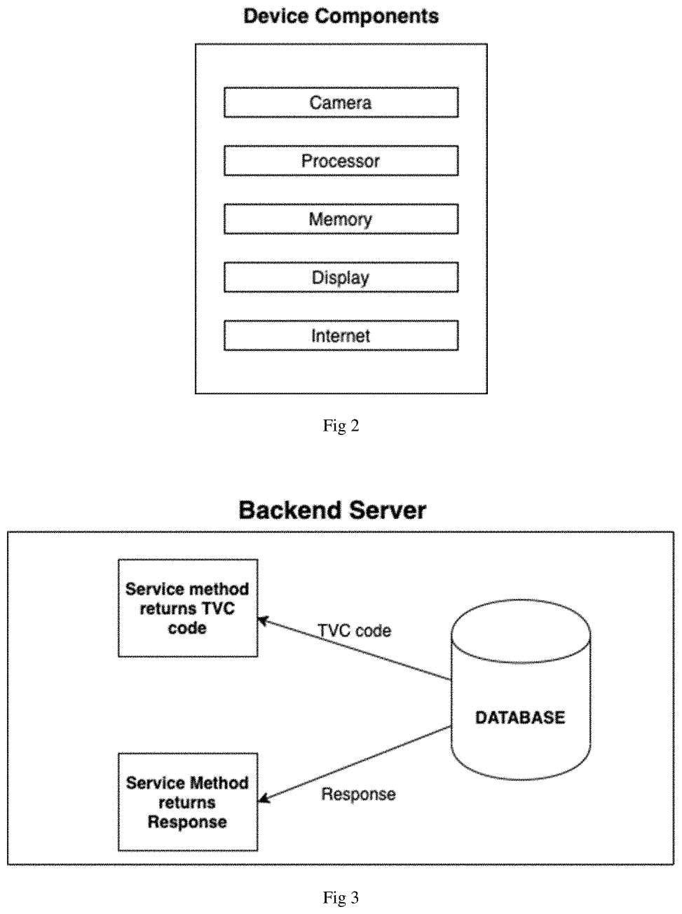

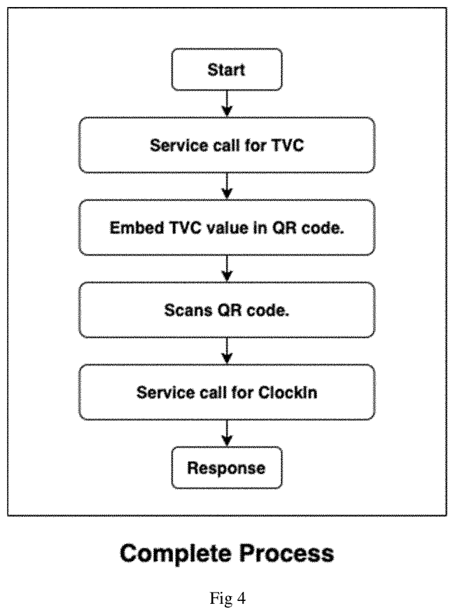

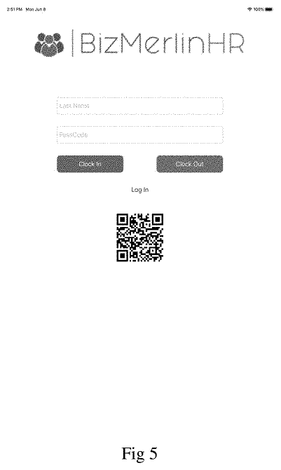

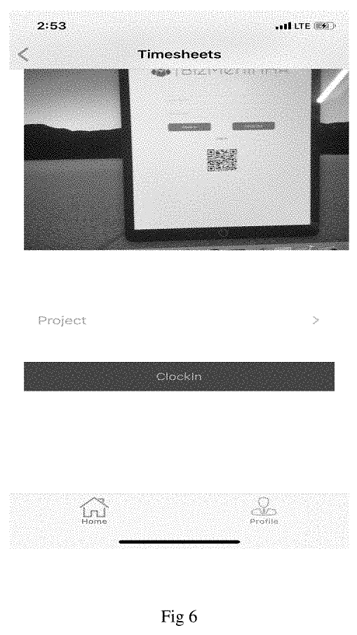

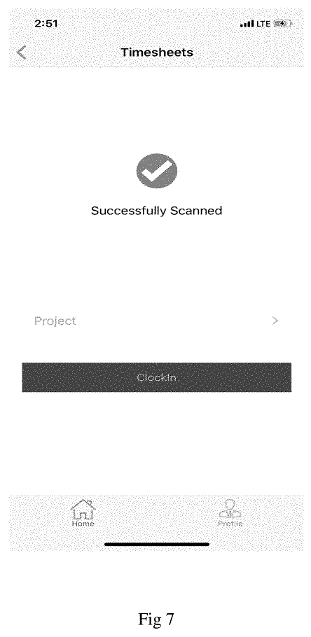

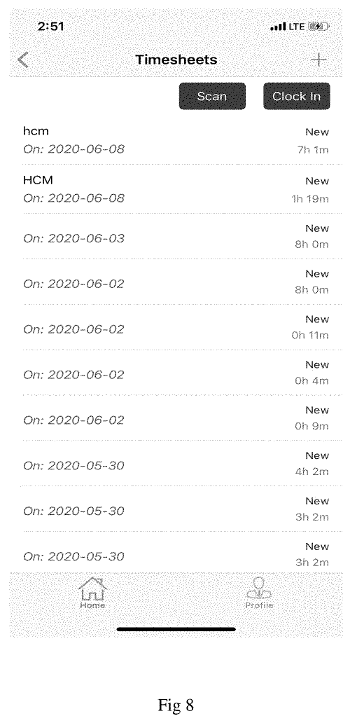

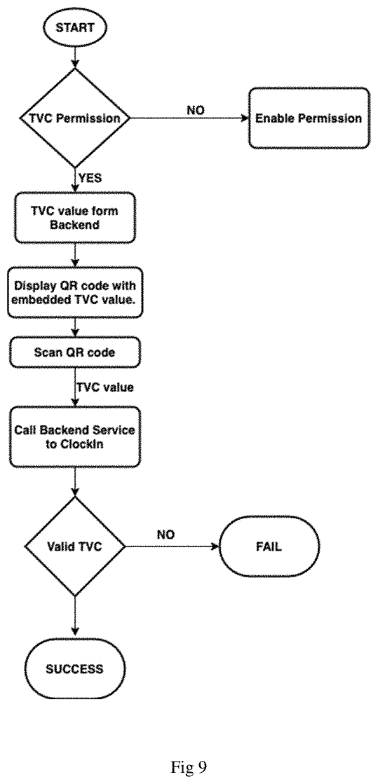

### COMPONENTS OF THE SYSTEM

1. Mobile Device with working Camera and Internet connection.
2. Backend Server.

### BACKGROUND

The present disclosure generally relates to contactless clock-in, clock-out systems and methods. In particular, the present disclosure relates to systems and methods for carrying out quick response (“QR”) code-enabled clock-in and clock-out process.

The present disclosure pertains to “contactless” mechanism, in which the mobile device is held at a distance from another device, and the person does not need to touch keypad or fingerprinting reader like device with their own hands.

In-person clock-in typically requires the use of contact with the common device either using the fingerprint or with the help of a 4-digit PIN. However, if we want to conduct a contactless clock-in, it can be difficult to complete the process without touching the device. The use of fingerprint or 4-digit PINs eliminates the necessity of manual record keeping of employee work hour management, but fingerprint or 4-digit PIN systems require the users to touch the device surface which is often unhygienic. Therefore, there is a need for improved systems and methods that overcome the problems of cost and inconvenience associated with typical clock-in options.

The present disclosure can work efficiently in almost all kinds of systems including hospitals, hotels, offices and in companies.

### SUMMARY

Consistent with a disclosed embodiment, a computer-implemented method is provided for completing a clock-in process. The method includes determining, by a processor, a true value for TVC Clock-In permission. The method also includes generating, by the processor, a QR code comprising a representation of the TVC value, and displaying, by the processor, the QR code on a display of the mobile device.

Consistent with a disclosed embodiment, an apparatus comprising another mobile device is provided for completing clock-in process, wherein the mobile device comprises a display, a memory storing instructions, a processor configured to execute the instructions and a stable Internet connection. The processor is configured to execute the instructions to determine a valid company account for providing login for the clock-in process. Also, the processor is configured to execute the instructions to receive a user request to scan and clock-in. The processor is further configured to execute the instructions to call a backend service to get TVC value and generate a QR code comprising a representation of the TVC value, and to display the QR code on the device display.

Consistent with a disclosed embodiment, a computer-implemented method is provided for completing a clock-in process using a mobile device comprising at least one processor and a camera. The method comprises configuring, by the processor, the camera to scan one or more QR codes. Further, the method includes scanning, by the camera, a QR code, wherein the QR code comprises TVC value representing a clock-in process. The method additionally comprises determining, by the processor, that the scanning of the QR code is completed. The method further includes displaying, on a display associated with the mobile device, a notification that the scanning of the QR code is completed. Also, the method comprises transmitting, by the processor, the TVC value representing the clock-in, wherein the TVC value is obtained from the scanned QR code to the backend server.

Consistent with a disclosed embodiment, an apparatus comprising a mobile device is provided for completing a clock-in, wherein the mobile device comprises a display, a camera, a memory storing instructions, internet connection and a processor configured to execute the instructions. The processor is configured to execute the instructions to configure the camera to scan one or more QR codes. Further, the processor is configured to execute the instructions to scan, by the camera, a QR code, wherein the QR code comprises TVC value representing Clock-in process. The processor is additionally configured to execute the instructions to determine that the scanning of the QR code is completed. Also, the processor is configured to execute the instructions to display a notification that the scanning of the QR code is completed on the display. The processor is further configured to transmit the TVC value representing the clock-in, wherein the TVC value is obtained from the scanned QR code.

Consistent with a disclosed embodiment, a backend system is provided for processing a clock-in process, wherein the system comprises a memory storing instructions and a processor configured to execute the instructions. The processor is configured to execute the instructions to receive a service request from a mobile device comprising TVC value representing a clock-in process, wherein the TVC value is obtained from a scanned QR code and it is connected to the database for processing the request. Additionally, the processor is configured to execute the instructions to analyze information contained within the TVC value representing the clock-in process, wherein the information comprises a valid TVC value, user authentication information and the projectId in which the user wants to clock-in.

The backend processor is further configured to execute the instructions to determine the customer associated with the company. Also, the processor is configured to execute the instructions to request the valid TVC for the user to clock-in. The processor also is configured to execute the instructions to display a success message after the success response from the server. The processor first authenticates the user against the request and then it compares the TVC value with the latest TVC value from the database.

Finally, clocks-in after with the current timestamp in the database, passing all the validation and returns a success response. If any of the authentication or validation fails, then the service simply returns the failure response back to the requesting device.

Consistent with other disclosed embodiments, the TVC value is time bound value which is valid only for a certain period of time and automatically updates. Also, the device with the QR code display calls a service to get the most recent TVC value from the database and embed that in the QR code. The purpose of making the TVC value time bound is to avoid the misuse of a constant TVC value by taking a picture and sharing it.

Consistent with other disclosed embodiments, tangible, non-transitory computer-readable storage media may store program instructions, which are executed by a processor and perform any of the methods described herein.

### PRIOR ART

U.S. Pat. No. 97,014,157B1: System and Method for Mobile Wallet

U.S. patent Ser. No. 10/346,849B2: Communicating personalized messages using quick response (QR) codes

China Pat. No. CN106447287A: Attendance method and system based on QR code

China Pat. No. CN106023332B: Based on Quick Response Code, location technology and the attendance checking system of recognition of face and method

China Pat. No. CN105373981A: Classroom check attendance system and method

1. A method for completing a clock-in process using a mobile device comprising a processor, a camera and an internet connection, comprising:
a. configuring, by the processor, the camera to scan one or more QR codes;
b. calling a service method to get the most recent TVC value from the database and embedding it into the QR code.
c. scanning, by the camera, a QR code, wherein the QR code comprises TVC value representing a clock-in process used to process the QR code;
d. determining, by the processor, that the scanning of the QR code is completed;
e. displaying, on a display associated with the mobile device, a notification that the scanning of the QR code is completed; and
f. transmitting, by the processor, the TVC value representing the clock-in process involves:
1. Calling the backend service method at the press of a button and sending Project identifier and TVC value as a parameter to the service method.
2. Getting a success response from the backend service if the TVC value is valid.

2. The method of claim 1, wherein the TVC value representing the clock-in within the QR code is a time bound value whose value is valid only for a certain time so that no one can take the snapshot of the TVC code based QR code and avoid its misuse.

3. The method of claim 1, wherein scanning, by the camera, a QR code further comprises scanning a QR code displayed on a second mobile device.

4. The method of claim 1, wherein scanning, by the camera, a QR code further comprises scanning a printed QR code.

5. The method of claim 1, wherein the calling the service to get TVC value is an automated process to update the TVC value after a fixed interval of time and at the same time updating it in the device displaying QR code.

6. The method of claim 1, wherein transmitting requires an Internet connection to call the backend service method.

7. The method of claim 1, wherein the mobile device, comprising:
a. a display;
b. a camera;
c. an Internet Connection
d. a memory storing instructions; and
e. a processor configured to execute the instructions to: configure, by the processor, the camera to scan one or more QR codes; scan, by the camera, a QR code, wherein the QR code comprises TVC value representing a clock-in;
f. determine, by the processor, that the scanning of the QR code is completed; display a notification that the scanning of the QR code is completed on the display;
g. transmitted, by the processor, the TVC value representing the clock-in to a backend service with projectId passed as parameter to the service method, wherein the TVC value is obtained from the scanned QR code.
h. Getting success response from backend service and displaying it on mobile display.

8. The mobile device of claim 6, wherein scanning, by the camera, a QR code further comprises scanning a QR code displayed on a second mobile device.

9. The mobile device of claim 6, wherein the processor is further configured to execute the instructions to receive an electronic transmission comprising a QR code;
a. print the QR code onto media; and
b. scan the printed QR code from the media.

10. A system for processing a clock-in process using mobile devices, comprising:
a. a memory storing instructions; and
b. a processor configured to execute the instructions to:
i. receive a transmission from a mobile device comprising TVC value and ProjectId representing a clock-in process and user authentication associated with an application of a mobile device user to the backend service method.
ii. connection with database for validating TVC value, authentication and clock-in.
iii. authenticates the user from the database.
iv. validates the TVC value from Database.
v. proceeds with the clock-in for the authorized user with current time as clock-in time.
vi. returns successfully clocked-in.

11. The system of claim 9, wherein the processor is further configured to execute the instructions to:
a. determine that the TVC value representing the clock-in comprises a Time Verification Code comprising identification information about the first application user of a mobile device that is associated with the source account;
b. read the Time Verification Code; and
c. validate the authentication information with the Time Verification Code.

12. The system of claim 9, wherein the processor is further configured to execute the instructions to transmit a notification comprising a confirmation that the clock-in was completed to the application use as response from the service method.
